(19) United States
(12) Patent Application Publication
(10) Pub. No.: US 2020/0160303 A1
(43) Pub. Date: May 21, 2020

(54) METHOD AND SYSTEM FOR AUDIT, VERIFICATION, AND SETTLEMENT OF ROYALTY AND LICENSE FEES IN THE MUSIC INDUSTRY

(71) Applicant: Rylti, LLC, Woodbury, NY (US)

(72) Inventors: Peter Fiorillo, Babylon, NY (US); Russell Safirstein, Muttontown, NY (US); Joseph Glick, Waterbury, CT (US)

(21) Appl. No.: 16/555,611

(22) Filed: Aug. 29, 2019

Related U.S. Application Data
(60) Provisional application No. 62/769,024, filed on Nov. 19, 2018.

(51) Int. Cl. G06Q 20/14; G06N 20/00; G06F 16/68; G06F 16/61

(52) U.S. Cl. CPC G06Q 20/145; G06F 16/61; G06F 16/68; G06N 20/00

(57) ABSTRACT

A process for audit, verification, and settlement of royalty and license fees in the music industry, is described, including receiving a format-agnostic music-related data set comprising royalty parameters, applying a normalization process to obtain normalized music-related data and to resolve entities within the music-related data set into normalized royalty parameters; receiving a user-selectable scope for processing the normalized music-related data; applying the selected scope and the normalized music-related data to a global music industry data model to generate optimized royalty data; calculating royalty fees based on the optimized royalty data; and presenting the calculated royalty fees.

Embodiments described herein generally relate to entity resolution, and more specifically to a method and system for audit, verification, and settlement of royalty and license fees in the music industry.

### BACKGROUND ART

The music industry is highly complex with multiple licenses and royalty owners. Recent legislation supports the need to help obtain better and more timely payment of license and royalty fees. Each entity that is part of the industry is concerned about cost, timing and accuracy, which affects retaining/losing talent & customers, and maximizing income from leased or owned licenses. Currently, the data reported from various entities is inconsistent, increasing the likelihood and costs of audits, and tying up massive staff and financial resources. The increased consumption of music via Digital Service Providers (DSPs) has shifted the industry to more digitally focused royalty payments.

Previously, license owners were held to only being able to validate the payments due via sample-based manual audit processes. Accordingly, the data considered was often limited and/or unrepresentative of actual royalties owed. These are inefficient and not very effective, leaving much subjectivity and little transparency to the process.

### SUMMARY

In one embodiment, a method for determining royalty fees from diverse sources is described. The method may include receiving, from a plurality of sources, a music-related data set comprising royalty parameters, wherein the music-related data set comprises a plurality of records inconsistent data formats, applying a normalization process to obtain normalized music-related data and to resolve entities within the music-related data set into normalized royalty parameters, wherein the normalized music-related data comprises a plurality of updated records with consistent data formats, receiving, via user input, a user-selectable scope for processing the normalized music-related data, accessing a global music industry data model comprising global royalty parameters, applying the selected scope and the normalized music-related data to the global music industry data model to generate royalty data, calculating royalty fees for the selected scope based on the royalty data, and presenting the calculated royalty fees.

### BRIEF DESCRIPTION OF DRAWINGS

FIG. 1 is a diagram for automatically generating royalty data based on incomplete input, according to one or more embodiments.

FIG. 2 is a diagram illustrating a flow diagram for a platform for providing auditing services for the music industry, according to one or more embodiments.

FIG. 3 is a system diagram illustrating a distributed system for an enhanced auditing platform for the music industry, according to one or more embodiments.

### DESCRIPTION OF EMBODIMENTS

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes, and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers' specific goals (e.g., compliance with system and business-related constraints), and that these goals will vary from one implementation to another. It will also be appreciated that such development efforts might be complex and time consuming, but would nevertheless be a routine undertaking for those of ordinary skill in the art of entity resolution having the benefit of this disclosure.

As used herein, the term “computer system” can refer to a single programmable device or a plurality of programmable devices working together to perform the function described as being performed on or by the computer system.

As used herein, the term “medium” refers to a single physical medium or a plurality of media that together store what is described as being stored on the medium.

As used herein, the term “network device” can refer to any programmable device that is capable of communicating with another programmable device across any type of network.

Generally, data related to the music industry may be presented in myriad forms for purposes or royalty audits. Many different parties have unique schemas for providing auditors data. Further the data received from the various parties may be skewed or incomplete. As an example, the data may not include every party related to a particular record. For example, a particular recording of a particular song may be associated with artist specific to that recording. Further, because the music-related data set may be in a unique format, time and resources are consumed.

This disclosure describes methods and systems for utilizing artificial intelligence algorithms, pattern analysis, cognitive computing and machine learning in the music industry. In one or more embodiments, a neural network architecture can compare and use input on a “MANY-TO-Many” basis, comparing data from multiple sources to identify multiple areas where the “Unmatched” royalties are being captured. Embodiments described herein are directed to an automated system and platform that utilizes artificial intelligence and machine learning to regularize format-agnostic data to identify normalized royalty parameters through entity resolution, and provide a global industry model for the music industry to more efficiently and more completely identify all parties to which royalties are owed. With respect to the normalized royalty parameters, data may be obtained from numerous data sources, such as a data bank of royalty agreements from entities within the music industry, or auditing records prepared for and/or provided by auditors. The various records may be used to train a machine learning model, such as a decision tree, a neural network, or any other type of machine learning model, to categorize various royalty-related data into normalized royalty parameters.

With respect to the global industry model, the model may be developed by applying artificial intelligence or a machine learning model to various music industry-specific data in order to generate a global music industry model that captures various relationships between various parties and other royalty data, such as artists and other parties involved in a particular recording or affiliated with various groups, relationships between publishers, known royalty fees as outlined in royalty agreements, and the like. Data may be obtained from numerous resources to develop such an industry model, such as records from digital service providers (“DSPs”), record contracts, sales data, agreements between distributors, record producers, streaming services, retailers, and the like.

In general, embodiments are directed to a set of platforms, modules, services, and the like which may be utilized on a local device or provided over a network, such as a cloud-based service, which leverages the regularized royalty parameters and/or global data model for purposes of royalty accounting & auditing to drive down costs and validate royalty and licensing-based payments, on a timely and accurate basis.

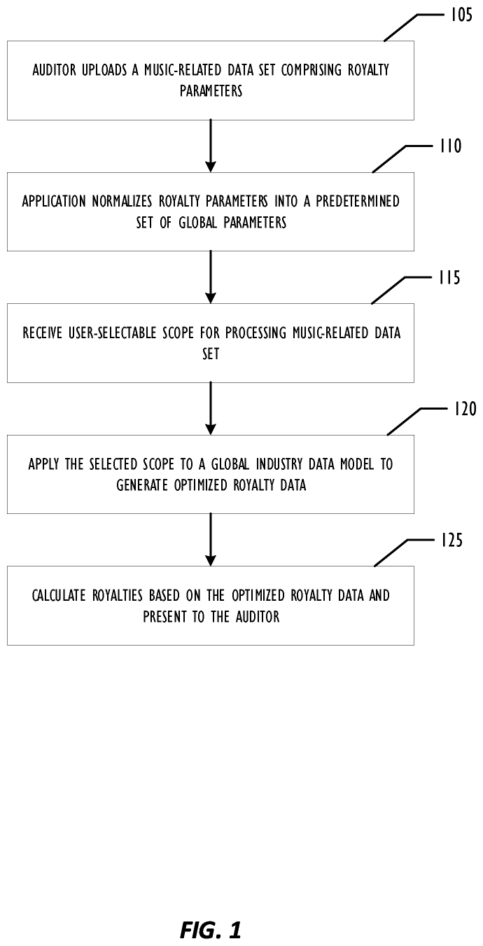

Turning to FIG. 1, a flow diagram is presented which illustrates a method for automatically generating royalty data based on potentially incomplete input, according to one or more embodiments. Although the various steps are depicted in a particular order, in one or more embodiments, the various steps may be depicted in a different order. Further, according to one or more embodiments, any of the various steps may be omitted or may occur concurrently.

The flowchart begins at 105, where an auditor uploads a music-related data set comprising royalty parameters. In one or more embodiments, the royalty parameters may not yet be normalized. Further, in one or more embodiments, the data may be format-agnostic because the specific format of the data set is not yet normalized. In one or more embodiments, the data set may be in the form of a spreadsheet, a database, a table or any other data structure. The data set may include data from royalty agreements, and/or other data germane to auditing royalty information in the music industry.

According to one or more embodiments, the music-related data set may come from multiple sources, such as multiple digital service providers (DSPs). Further, the format of the music-related data set may be inconsistent, or may contain errors. For example, artists or groups may be identified inconsistently, or data may be categorized or otherwise labeled inconsistently. In one or more embodiments, the data set may be consistent across multiple sources, and/or may be inconsistent even within a same source. The royalty parameters may include categories or labels applied to data within the music-related data set. The royalty parameters may include for example, artists, groups, musicians, record labels, arrangements, and other data related to a recording and utilized to determine royalties owed with respect to that recording (e.g., play dates, play durations, configuration—download or stream, revenue type—per play, monthly fee or ad based).

The flowchart continues at 110, where the royalty auditing application and/or platform normalizes royalty parameters utilizing a predetermined set of global parameters. For purposes of clarity, the term royalty auditing application may additionally or alternatively refer to the royalty auditing platform throughout. As such, the royalty auditing application is format-agnostic, meaning the royalty auditing application may receive as input royalty data regardless of data format, and may normalize the data into a consistent format. In one or more embodiments, the normalization may be processed locally on an auditor's local machine, or may submitted to a remote portion of the platform, such as a cloud-based module, for processing.

According to one or more embodiments, the normalization process may include applying a machine learning algorithm to the music-related data set to identify normalized royalty parameters for the data set. A key architecture is an Adaptive Metadata Ontology. For each object attribute that needs to be filled, a weighted list of keywords is kept. This starts out with the words in the attribute name or description (omitting grammar words, such as words merely utilized for grammatical purposes, and not identifiable of a particular name or description), which are given a heavy start weight. In one or more embodiments, a predetermined number of words may be used, for example the 15 or 20 words with a heaviest starting weight. Each time a user uploads a data set, such as a table, for each attribute he or she is presented the list of columns to choose from, sorted by the total weight of the keywords for that attribute in each column's header. Hence, the likeliest choices are at the top of the list.

Once the user makes the final selection for that attribute, the weight of any keywords found in that column header is increased by one. In addition, any other words in that column header (besides grammar words) are added to the keyword list for that attribute, with a starting weight of 1. Hence, the ontology learns from choices made by the users.

As an example, the normalization process may ensure that song titles are actually listed as song titles (i.e., categorized correctly). As another example, the normalization process may uniquely identify various parties, for example, when names provided within the music-related data set are substantially similar, the two names may be determined to likely belong to the same entity. As yet another example, based on a source, the normalization process may better identify sub-categories when the raw data does not distinguish between such sub-categories, such as data records related to digital sources and physical product sales.

In one or more embodiments, the normalized data may be presented to the user for confirmation. That is, data records that have been found to need modifications by the machine learning algorithm may be presented via a user interface for confirmation. Further, in one or more embodiments, if the user identifies an error, the user may address the error, and the error correction is fed back into the normalization algorithm such that the user feedback is taken into account in future uses of the normalization process. As an example, the algorithm may be weighed to account for the

At 115, the application receives a user-selectable scope for processing the music-related data set. As an example, the royalty auditing application may provide a user interface within which an auditor or other user may generate a royalty report. In one or more embodiments, the user interface may include a customizable interface that allows the user to select from among the various normalized royalty parameters (i.e., by artist, DSP, title, and the like). Further, in one or more embodiments, the user may select from among additional parameters, such as a time within which royalties should be calculated, the configuration or the revenue type.

The flowchart continues at 120, and the selected scope is applied to a global industry data model to generate optimized royalty data. According to one or more embodiments, the global industry data model may utilize a neural architecture to model complex relationship between song titles, sales channels, and royalty accounts. As such, the normalized royalty data, now associated with normalized royalty parameters, may be applied to the global industry data model to identify missing data and/or to confirm that the music-related data set is complete. Further, in one or more embodiments, the global industry data model may be used to identify additional relationships, for example through deep learning techniques, to provide additional context to the user. In addition, the global industry data model may be used to validate the data that is in the music-related data set. As an example, irrelevant or questionable entries may be identified and flagged to the user.

The flowchart concludes at 125, where royalty fees are calculated by the application and/or platform based on the optimized royalty data and presented to the user. Further, in one or more embodiments, the application may provide the option for the user to download the results. In one or more embodiments, the download options may allow a user to select a format or file type in which to download the results.

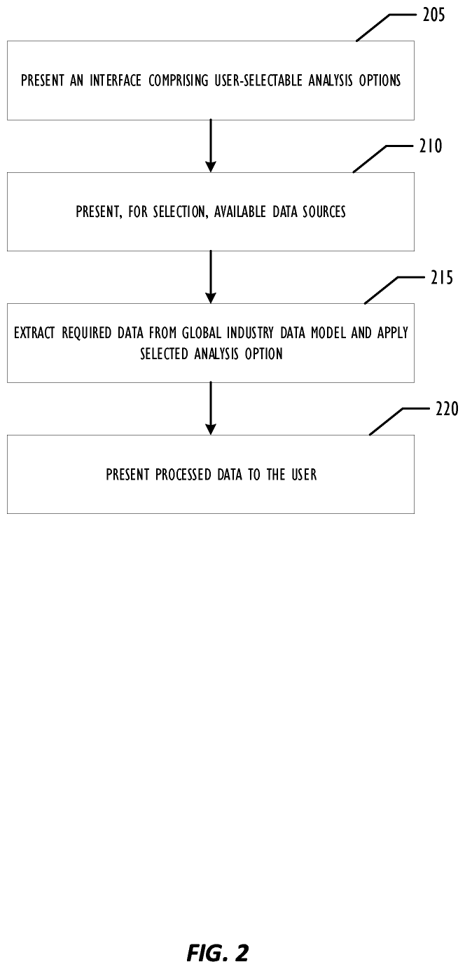

FIG. 2 is a diagram illustrating a flow diagram for a platform for providing auditing services for the music industry, according to one or more embodiments. Although the various steps are depicted in a particular order, in one or more embodiments, the various steps may be depicted in a different order. Further, according to one or more embodiments, any of the various steps may be omitted or may occur concurrently.

The flowchart begins at 205, where an interface is presented comprising user-selectable analysis options, e.g. underpayments over a selected threshold, compare high-volume plays across two or more DSPs or common factors for major underpayments. That is, the user interface may indicate various high level analysis processes which may be applied to the results received as described in FIG. 1. The flowchart continues at 210, where the application presents available data sources for selection by a user. As described above, data sources may include various DSPs or other providers of data related to royalty fees, such as record companies and the like. In addition, relevant analytic method for the data sources may be presented as selectable by the user. The relevant analytic methods for the data sources may be related to royalty and license fees in the music industry.

At 215, required data is extracted from the global industry data model and applied to the selected analysis option. The global industry data model is built in a neural structure that defines potential data relationships between licensors and licensees and enabled analytical processes. The neural structure allows overlapping and potentially conflicting many-to-many relationships to be defined. The relationship definitions are maintained using a combination of the Adaptive Metadata Ontology process described above and curation by multidisciplinary subject matter experts. Associated with each analysis process are rules that use computable context representation methods to select appropriate elements of the global model to compare with the available audit datasets. As described above, an auditor may rely on the global industry data model to identify missing data from the music-related data set. Finally, at 220, the flow diagram concludes by presenting the processed data to the user, enabling viewing the high-level results on screen and drilling down to the underlying evidence or details. For example, if the results propose that data is missing, a comparison to the global model regarding the relevant data may be presented to the user. If the user wants to make some adjustment to the results, the adjustment would be added to analysis type as a potential rule associated with the specific scenario selected, and would be shown to future users who select to view additional options to the standard analysis. Further, in one or more embodiments, the application may provide the option for the user to download the results. In one or more embodiments, the download options may allow a user to select a format in which to download the results.

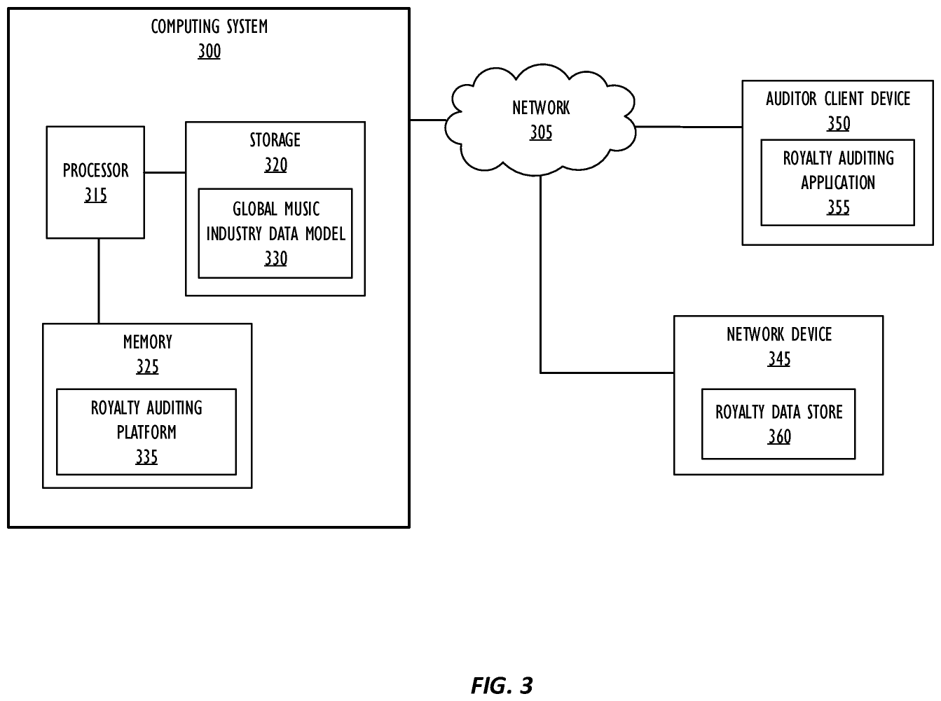

FIG. 3 is a system diagram illustrating a distributed system for an enhanced auditing platform for the music industry, according to one or more embodiments. FIG. 3 includes a computing system 300 connected to one or more network devices 345 and other devices such as client device 350 across a network 305. Computing system 300 may be, for example, one or more server devices or other computing devices. Further, computing system 300 may be a distributed network system, such as a network cloud, across which the various components and functionality described within computing system 300 are distributed. Network device 345 may include any kind of device accessible across network 305, with which computing system 300 may communicate, and which may provide relevant royalty data, such as from royalty data store 360. For example, network device 345 may be an additional computing system, a server, a remote computer, or the like. Further, network device 345 may be controlled by the same or different entity as computing system 300 and/or auditor client device 350. Network 305 may include many different types of computer networks available today, such as the Internet, a corporate network, a Local Area Network (LAN), or a personal network, such as those over a Bluetooth connection. Each of these networks can contain wired or wireless programmable devices and operate using any number of network protocols (e.g., TCP/IP). Network 305 may be connected to gateways and routers, servers, and end user computers.

According to one or more embodiments, computing system 300 may include, for example, a storage 320, a memory 325 and processor 315. Processor 315 may include a single processor or multiple processors. Further, in one or more embodiment, processor 315 may include different kinds of processors, such as a central processing unit (“CPU”) and a graphics processing unit (“GPU”). Memory 325 may include a number of software or firmware modules executable by processor 315. Memory 325 may include a single memory device or multiple memory devices. As depicted, memory 325 may include a royalty auditing platform 335. The royalty auditing platform 335 may be a process automation platform that provides automated services for audit, verification, and settlement of royalty and license fees in the music industry. Memory 325 may be operatively coupled to processing element 315. Memory 325 may be a non-transitory medium configured to store various types of data. For example, memory 325 may include one or more memory devices that comprise a non-volatile storage device and/or volatile memory. Volatile memory, such as random access memory (RAM), can be any suitable non-permanent storage device. The non-volatile storage devices can include one or more disk drives, optical drives, solid-state drives (SSDs), tap drives, flash memory, read only memory (ROM), and/or any other type memory designed to maintain data for a duration time after a power loss or shut down operation. In certain instances, the non-volatile storage device may be used to store overflow data if allocated RAM is not large enough to hold all working data. The non-volatile storage device may also be used to store programs that are loaded into the RAM when such programs are selected for execution. As described above, the royalty auditing platform 335 may utilize a global industry data model 330, which may be stored in storage 320. Storage 320 may include a single storage device, or multiple storage devices.

Persons of ordinary skill in the art are aware that software programs may be developed, encoded, and compiled in a variety of computing languages for a variety software platforms and/or operating systems and subsequently loaded and executed by processing element 315. In one embodiment, the compiling process of the software program may transform program code written in a programming language to another computer language such that the processing element 315 is able to execute the programming code. For example, the compiling process of the software program may generate an executable program that provides encoded instructions (e.g., machine code instructions) for processor 315 to accomplish specific, non-generic, particular computing functions.

After the compiling process, the encoded instructions may then be loaded as computer executable instructions or process steps to processing element 315 from storage (e.g., memory 325) and/or embedded within the processing element 315 (e.g., cache). Processing element 315 can execute the stored instructions or process steps in order to perform instructions or process steps to transform the computing device into a non-generic, particular, specially programmed machine or apparatus. Stored data, e.g., data stored by a storage device, can be accessed by processing element 315 during the execution of computer executable instructions or process steps to instruct one or more components within the computing system 300.

Royalty auditing application 360 may provide a local application to an auditor on an auditor client device 350, or any user on a user client device. In one or more embodiments, royalty auditing application 355 may provide some or all of the functionality as described above with respect to FIGS. 1-2. Further, royalty audition application 355 may provide an interface such that a user of auditor client device 350 may utilize the various components and functionality of computing system 300. A user interface can include a display, positional input device (such as a mouse, touchpad, touchscreen, or the like), keyboard, or other forms of user input and output devices. When the output device is or includes a display, the display can be implemented in various ways, including by a liquid crystal display (LCD) or a cathode-ray tube (CRT) or light emitting diode (LED) display, such as an OLED display.

Persons of ordinary skill in the art are aware that the various devices and systems in FIG. 3 may comprise other components well known in the art, such as sensors, powers sources, and/or analog-to-digital converters, not explicitly shown in FIG. 3. Further, the programmable devices depicted in FIG. 3 are a schematic illustration of embodiments of programmable devices which may be utilized to implement various embodiments discussed herein

It is to be understood that the various components of the flow diagrams described above, could occur in a different order or even concurrently. It should also be understood that various embodiments of the inventions may include all or just some of the components described above. Thus, the flow diagrams are provided for better understanding of the embodiments, but the specific ordering of the components of the flow diagrams are not intended to be limiting unless otherwise described so.

It is to be understood that the above description is intended to be illustrative, and not restrictive. For example, the above-described embodiments may be used in combination with each other. As another example, the above-described flow diagrams include a series of actions which may not be performed in the particular order depicted in the drawings. Rather, the various actions may occur in a different order, or even simultaneously. Many other embodiments will be apparent to those of skill in the art upon reviewing the above description. The scope of the invention should therefore be determined with reference to the appended claims, along with the full scope of equivalents to which such claims are entitled.

What is claimed is:

1. A method for determining royalty fees from diverse sources, comprising:
receiving, from a plurality of sources, a music-related data set comprising royalty parameters, wherein the music-related data set comprises a plurality of records in inconsistent data formats;
applying a normalization process to the music-related data set obtain normalized music-related data and to resolve entities within the music-related data set into normalized royalty parameters, wherein the normalized music-related data comprises a plurality of updated records with consistent data formats;
receiving, via user input, a user-selectable scope for processing the normalized music-related data;
accessing a global music industry data model comprising global royalty parameters;
applying the selected scope and the normalized music-related data to the global music industry data model to generate royalty data;
calculating royalty fees for the selected scope based on the royalty data; and
presenting the calculated royalty fees.

2. The method of claim 1, wherein the normalization process comprises a machine learning algorithm.

3. The method of claim 1, further comprising:
presenting at least part of the normalized music-related data for confirmation;
receiving, in response to the at least part of the normalized music-related data, and indication that the normalized music-related data is inaccurate, and
in response to the indication that the normalized music-related data is inaccurate, modify the normalization process based on an indicated inaccuracy.

4. The method of claim 1, wherein presenting the calculated royalty fees further comprises presenting a plurality of options for saving the presented royalty fees.

5. The method of claim 1, wherein the global industry data model is utilized to supplement the received music-related data set.

6. The method of claim 1, wherein the global industry data model is utilized to identify parties unidentified in the music-related data set.

7. The method of claim 1, further comprising:
presenting an analysis interface comprising user-selectable analysis options;
receive user-selectable analysis options;
extract analysis data from global industry data model based on the received user-selectable analysis options; and
apply the global industry data model to the user-selectable analysis options.

8. A computer readable medium comprising computer readable code for determining royalty fees from diverse sources, the computer readable code executable by one or more processors to:
receive, from a plurality of sources, a music-related data set comprising royalty parameters, wherein the music-related data set comprises a plurality of records in inconsistent data formats;
apply a normalization process to the music-related data set obtain normalized music-related data and to resolve entities within the music-related data set into normalized royalty parameters, wherein the normalized music-related data comprises a plurality of updated records with consistent data formats;
receive, via user input, a user-selectable scope for processing the normalized music-related data;
access a global music industry data model comprising global royalty parameters;
apply the selected scope and the normalized music-related data to the global music industry data model to generate royalty data;
calculate royalty fees for the selected scope based on the royalty data; and
present the calculated royalty fees.

9. The non-transitory computer readable medium of claim 8, wherein the normalization process comprises a machine learning algorithm.

10. The non-transitory computer readable medium of claim 8, further comprising computer readable code to:
present at least part of the normalized music related data for confirmation;
receive, in response to the at least part of the normalized music-related data, and indication that the normalized music-related data is inaccurate, and
in response to the indication that the normalized music-related data is inaccurate, modify the normalization process based on an indicated inaccuracy.

11. The non-transitory computer readable medium of claim 8, wherein presenting the calculated royalty fees further comprises presenting a plurality of options for saving the presented royalty fees.

12. The non-transitory computer readable medium of claim 8, wherein the global industry data model is utilized to supplement the received music-related data set.

13. The non-transitory computer readable medium of claim 8, wherein the global industry data model is utilized to identify parties on identified in the music-related data set.

14. The non-transitory computer readable medium of claim 8, further comprising computer readable code to:
present an analysis interface comprising user-selectable analysis options;
receive user-selectable analysis options;
extract analysis data from global industry data model based on the received user-selectable analysis options; and
apply the global industry data model to the user-selectable analysis options.

15. A system for determining royalty fees from diverse sources, comprising:
one or more processors; and
one or more computer readable media comprising computer readable code executable by one or more processors to:
receive, from a plurality of sources, a music-related data set comprising royalty parameters, wherein the music-related data set comprises a plurality of records in inconsistent data formats;
apply a normalization process to the music-related data set obtain normalized music-related data and to resolve entities within the music-related data set into normalized royalty parameters, wherein the normalized music-related data comprises a plurality of updated records with consistent data formats;
receive, via user input, a user-selectable scope for processing the normalized music-related data;
access a global music industry data model comprising global royalty parameters;
apply the selected scope and the normalized music-related data to the global music industry data model to generate royalty data;
calculate royalty fees for the selected scope based on the royalty data; and
present the calculated royalty fees.

16. The system of claim 15, wherein the normalization process comprises a machine learning algorithm.

17. The system of claim 15, further comprising computer readable code to:
present at least part of the normalized music-related data for confirmation;
receive, in response to the at least part of the normalized music-related data, and indication that the normalized music-related data is inaccurate, and
in response to the indication that the normalized music-related data is inaccurate, modify the normalization process based on an indicated inaccuracy.

18. The system of claim 15, wherein presenting the calculated royalty fees further comprises presenting a plurality of options for saving the presented royalty fees.

19. The system of claim 15, wherein the global industry data model is utilized to supplement the received music-related data set.

20. The system of claim 15, further comprising computer readable code to:
present an analysis interface comprising user-selectable analysis options;
receive user-selectable analysis options;
extract analysis data from global industry data model based on the received user-selectable analysis options; and
apply the global industry data model to the user-selectable analysis options.
